(19) United States
(12) Patent Application Publication
(10) Pub. No.: US 2026/0360987 A1
(43) Pub. Date: Nov. 12, 2026

(54) QUASI-QUADRIFILAR HELIX ANTENNA

(71) Applicant: Shenzhen Ant SatCom Technology Co., Ltd., Shenzhen (CN)

(72) Inventors: Haiyan PIAO, Shenzhen (CN); Longyue QU, Shenzhen (CN); Rui LI, Shenzhen (CN); Yang LIU, Shenzhen (CN); Haiyang PIAO, Shenzhen (CN)

(73) Assignee: Shenzhen Ant SatCom Technology Co., Ltd., Shenzhen (CN)

(21) Appl. No.: 19/248,086

(22) Filed: Jun. 24, 2025

(30) Foreign Application Priority Data
May 6, 2025 (CN) 2025105718897

(51) Int. Cl. H01Q 11/08

(52) U.S. Cl. CPC H01Q 11/08

(57) ABSTRACT

The invention relates to the field of antenna technology, in particular to a quasi-quadrifilar helix antenna. The quasi-quadrifilar helix antenna comprises a ground plate, active radiation arms, and passive radiation arms, wherein the active radiation arms and the passive radiation arms are connected to the ground plate, the active radiation arms are fed with differential signals to generate antenna resonance, and the passive radiation arms couple with the active radiation arms that receive the differential signals to create parasitic resonance; and the two active radiation arms and the two passive radiation arms are sequentially arranged in a helically symmetric configuration around a central region of the antenna, with a parasitic resonance frequency of the passive radiation arms deviating from an antenna resonance frequency of the active radiation arms.

### INCORPORATION BY REFERENCE

This application claims priority to China Patent Application No. 2025105718897 filed May 6, 2025, the contents of which are hereby incorporated by reference in their entirety.

### BACKGROUND OF THE INVENTION

### 1. Technical Field

The invention relates to the field of antenna technology, in particular to a quasi-quadrifilar helix antenna.

### 2. Description of Related Art

With the rapid development of wireless communications and satellite navigation technologies, the demand for high-performance, compact antennas is increasing. Particularly in applications such as Global Navigation Satellite Systems (GNSS), drone communications, vehicle positioning systems, and the Internet of Things (IoT), antennas need to exhibit stable radiation characteristics and achieve efficient signal transmission in space-constrained conditions. To enhance system reliability and anti-interference capabilities, circularly polarized antennas have become the preferred solution due to their excellent polarization matching and resistance to multipath effects. Among them, the quadrifilar helix antenna, as a typical circularly polarized antenna, has received widespread attention in these applications for its wideband characteristics and high gain performance. However, the design of traditional quadrifilar helix antennas still faces numerous challenges.

The prior art typically relies on four independent radiation arms and corresponding feed ports to achieve circularly polarized radiation. Each radiation arm requires a complex power distribution network and matching circuit to introduce a differential signal with a phase difference of 90 degrees, forming a uniform circularly polarized wave. However, this multi-port design and its associated circuitry significantly increase the design complexity and manufacturing costs of the antenna, making it difficult to integrate into miniaturized devices. Another self-phase method generates phase differences through the geometric symmetry of the radiation arms to achieve circular polarization, but it demands extremely high processing accuracy and is prone to reduced port-to-port isolation and deteriorated polarization performance under non-ideal orthogonal conditions, limiting its adaptability in complex environments.

To overcome the aforementioned issues, the prior art has proposed several improvements. For example, some designs attempt to reduce the number of feed ports to achieve circular polarization, but this often results in limited bandwidth or decreased gain, making it difficult to meet the requirements of multi-band, high-precision applications. Other solutions aim to reduce size by adjusting the geometric shape of the radiating arms or adding dielectric loading, but these typically lead to a loss in radiation efficiency or reduced design flexibility. Overall, traditional quadrifilar helix antennas struggle to effectively balance miniaturization, low cost, and high performance, particularly in modern communication systems where high integration is required, significantly limiting their application.

### BRIEF SUMMARY OF THE INVENTION

The invention provides a quasi-quadrifilar helix antenna designed to simplify the feeding structure and significantly reduce manufacturing complexity and costs, while achieving high port-to-port isolation and stable circular polarization performance in a compact layout.

The invention provides a quasi-quadrifilar helix antenna, comprising a ground plate, active radiation arms, and passive radiation arms, wherein the active radiation arms and the passive radiation arms are connected to the ground plate, the active radiation arms are fed with differential signals to generate antenna resonance, and the passive radiation arms couple with the active radiation arms that receive the differential signals to create parasitic resonance; and the two active radiation arms and the two passive radiation arms are sequentially arranged in a helically symmetric configuration around a central region of the antenna, with a parasitic resonance frequency of the passive radiation arms deviating from an antenna resonance frequency of the active radiation arms.

As a further improvement of the invention, the two active radiation arms are configured with either equal electrical lengths or unequal electrical lengths, and the two passive radiation arms are configured with either equal electrical lengths or unequal electrical lengths; and the electrical length of the active radiation arms is one of λ₀/4 or odd multiples thereof, or λ₀/2 or integer multiples thereof, and the electrical length of the passive radiation arms deviates from one of λ₀/4 or odd multiples thereof, or λ₀/2 or integer multiples thereof, λ₀ being a wavelength corresponding to an antenna operating frequency.

As a further improvement of the invention, the active radiation arms consist of a first active radiation arm and a second active radiation arm, and the passive radiation arms consist of a first passive radiation arm and a second passive radiation arm; one end of each of the first active radiation arm, the second active radiation arm, the first passive radiation arm, and the second passive radiation arm is connected to the ground plate; the first active radiation arm, the second active radiation arm, the first passive radiation arm, and the second passive radiation arm are sequentially arranged in a helically symmetric configuration around the central region of the antenna; and an electrical length of the first active radiation arm and the second active radiation arm is λ₀/4 or odd multiples thereof, and an electrical length of the first passive radiation arm and the second passive radiation arm deviates from λ₀/4 or odd multiples thereof;
or the active radiation arms consist of a third active radiation arm and a fourth active radiation arm, and the passive radiation arms consist of a third passive radiation arm and a fourth passive radiation arm; two ends of each of the third active radiation arm, the fourth active radiation arm, the third passive radiation arm, and the fourth passive radiation arm are connected to the ground plate; the third active radiation arm, the fourth active radiation arm, the third passive radiation arm, and the fourth passive radiation arm are sequentially arranged in a helically symmetric configuration around the central region of the antenna; and an electrical length of the third active radiation arm and the fourth active radiation arm is λ₀/2 or integer multiples thereof, and an electrical length of the third passive radiation arm and the fourth passive radiation arm deviates from λ₀/2 or integer multiples thereof.

As a further improvement of the invention, the quasi-quadrifilar helix antenna further comprises first capacitive elements, wherein open ends of one or more of the first active radiation arm, the second active radiation arm, the first passive radiation arm, and the second passive radiation arm are electrically connected to the ground plate through the first capacitive elements respectively.

As a further improvement of the invention, the quasi-quadrifilar helix antenna further comprises first inductive elements, wherein ground ends of one or more of the first active radiation arm, the second active radiation arm, the first passive radiation arm, and the second passive radiation arm are electrically connected to the ground plate through the first inductive elements;
or one or two ends of one or more of the third active radiation arm, the fourth active radiation arm, the third passive radiation arm, and the fourth passive radiation arm are electrically connected to the ground plate through the first inductive elements.

As a further improvement of the invention, the active radiation arm and the passive radiation arm each have a vertical radiation branch and a horizontal radiation branch, with the vertical radiation branch connected to the ground plate, and the horizontal radiation branch connected to the vertical radiation branch and spiraling out in a horizontal plane to form a low-profile antenna structure.

As a further improvement of the invention, the quasi-quadrifilar helix antenna further comprises current branches for forming additional current paths, wherein one or more of the active radiation arms and the passive radiation arms are connected to the current branches.

As a further improvement of the invention, the quasi-quadrifilar helix antenna further comprises electromagnetic coupling branches that spatially electromagnetically couple to one or more of the active and/or passive radiation arms, wherein one or more of the active radiation arms and the passive radiation arms are equipped with the electromagnetic coupling branches, and the electromagnetic coupling branches are located on one sides of the active radiation arms and/or the passive radiation arms.

As a further improvement of the invention, the quasi-quadrifilar helix antenna further comprises feed branches, with each feed branch disposed on one side of the corresponding active radiation arm, wherein one end of each feed branch forms a coupling gap with the corresponding active radiation arm, and the other end of each feed branch is connected to a feed port.

As a further improvement of the invention, the quasi-quadrifilar helix antenna further comprises feed branches, wherein one end of each feed branch is connected to the corresponding active radiation arm, and the other end of each feed branch is connected to a feed port.

As a further improvement of the invention, the quasi-quadrifilar helix antenna further comprises first elements, wherein one end of each feed branch is connected in series with the corresponding active radiation arm through the corresponding first element, and the first element is a capacitive element, an inductive element, or a combination of both.

As a further improvement of the invention, the quasi-quadrifilar helix antenna further comprises second elements, wherein each second element is connected in parallel to one side of the corresponding feed branch, and the second element is a capacitive element, an inductive element, or a combination of both.

As a further improvement of the invention, the quasi-quadrifilar helix antenna further comprises a differential feed network and an RF chip, wherein the differential feed network is connected to the feed ports, and the RF chip is connected to the differential feed network.

As a further improvement of the invention, the quasi-quadrifilar helix antenna further comprises matching networks, a differential feed network, and an RF chip, wherein the differential feed network is connected to the active radiation arms through the matching networks, and the RF chip is connected to the differential feed network.

As a further improvement of the invention, the two active radiation arms are fed with differential signals that have a phase difference, with 90 degrees being a representative example.

As a further improvement of the invention, the active radiation arms fed with differential signals generate an antenna resonance frequency f₀, the passive radiation arms produce a parasitic resonance frequency f₁, and a frequency difference between f₀ and f₁ is controlled within ±20% of f₀.

As a further improvement of the invention, a smallest gap between any two radiation arms is smaller than 0.05λ₀, λ₀ being a wavelength corresponding to an antenna operating frequency.

The invention further provides an electronic device comprising the quasi-quadrifilar helix antenna.

The invention has the following beneficial effects:

The quasi-quadrifilar helix antenna functions similarly to a traditional quadrifilar helix antenna, capable of achieving equivalent circularly polarized radiation characteristics. However, by employing a combination of two active radiation arms and two passive radiation arms, it can complete differential signal input and circular polarization modulation using only two feed ports. Compared to traditional quadrifilar helix antennas that rely on a complex four-port feed network, this antenna design greatly simplifies the feeding structure and significantly reduces manufacturing complexity and costs, while achieving high port-to-port isolation and stable circular polarization performance in a compact layout.

Further, the parasitic resonance effect introduced by the passive radiation arms optimizes the energy distribution between the two active radiation arms, ensuring the symmetry and uniformity of the radiation pattern while enhancing design flexibility. The quasi-quadrifilar helix antenna offers a novel solution for circularly polarized antennas that are both miniaturized and exhibit high radiation efficiency, particularly suitable for high-demand applications such as GNSS, satellite communications, and next-generation wireless communication systems (e.g., 6G).

### BRIEF DESCRIPTION OF THE SEVERAL VIEWS OF THE DRAWINGS

FIG. 1 is a perspective view of a quasi-quadrifilar helix antenna according to Embodiment 1 of the invention;

FIG. 2 is a planar unfolded view of a quasi-quadrifilar helix antenna according to Embodiment 1 of the invention around a z-axis;

FIG. 3 is a current distribution diagram of a quasi-quadrifilar helix antenna according to Embodiment 1 of the invention;

FIG. 4 is a schematic diagram illustrating the working principle of differential feeding according to Embodiment 1 of the invention;

FIG. 5 is an equivalent circuit diagram of a quasi-quadrifilar helix antenna according to Embodiment 1 of the invention;

FIG. 6 is a planar unfolded view of a quasi-quadrifilar helix antenna according to Embodiment 2 of the invention around a z-axis;

FIG. 7 is a current distribution diagram of a quasi-quadrifilar helix antenna according to Embodiment 2 of the invention;

FIG. 8 is a perspective view of a low-profile quasi-quadrifilar helix antenna according to Embodiment 3 of the invention;

FIG. 9 is a planar unfolded view of a low-profile quasi-quadrifilar helix antenna according to Embodiment 3 of the invention in an xy plane;

FIG. 10 is a planar unfolded view of a low-profile quasi-quadrifilar helix antenna according to Embodiment 3 of the invention around a z-axis;

FIG. 11 is a structural diagram of a U-shaped radiation arm according to Embodiment 4 of the invention;

FIG. 12 is a schematic diagram of a radiation arm incorporating a capacitive element according to Embodiment 4 of the invention;

FIG. 13 is a schematic diagram of a radiation arm incorporating an inductive element according to Embodiment 4 of the invention;

FIG. 14 is a schematic diagram of a radiation arm with a first branch according to Embodiment 4 of the invention;

FIG. 15 is a schematic diagram of a radiation arm with a second branch according to Embodiment 4 of the invention;

FIG. 16 is a schematic diagram of a first feeding structure of a quasi-quadrifilar helix antenna according to Embodiment 5 of the invention;

FIG. 17 is a schematic diagram of a second feeding structure of a quasi-quadrifilar helix antenna according to Embodiment 5 of the invention;

FIG. 18 is a schematic diagram of a third feeding structure of a quasi-quadrifilar helix antenna according to Embodiment 5 of the invention;

FIG. 19 is a schematic diagram of a fourth feeding structure of a quasi-quadrifilar helix antenna according to Embodiment 5 of the invention;

FIG. 20 is a graph of scattering parameters for a quasi-quadrifilar helix antenna according to Embodiment 1 of the invention;

FIG. 21 is a graph of scattering coefficients when only two active radiation arms are present in the invention;

FIG. 22 is a graph of transmission coefficients varying with parasitic resonance (f₁) in the invention;

FIG. 23 is a graph of axial ratios varying with parasitic resonance (f₁) in the invention;

FIG. 24 is a graph of circular polarization gain varying with parasitic resonance (f₁) in the invention;

FIG. 25 is a graph of scattering coefficients for a traditional quadrifilar helix antenna; and

FIG. 26 is a graph of circular polarization gain for a traditional quadrifilar helix antenna.

### DETAILED DESCRIPTION OF THE INVENTION

In order to make the objectives, technical schemes and advantages of the invention more apparent, the invention is further described in detail in conjunction with the accompanying drawings and embodiments.

The invention relates to a miniaturized, lightweight circularly polarized antenna and a design method thereof, suitable for wireless communications and satellite navigation systems. Traditional quadrifilar helix antennas struggle to balance complexity, low cost, and high performance. To address this, the invention proposes a quasi-quadrifilar helix antenna. This design functions similarly to traditional quadrifilar helix antennas, achieving equivalent circularly polarized radiation characteristics, but innovatively utilizes two active radiation arms and two passive radiation arms, allowing differential signal feeding and circular polarization modulation with just two ports. Compared to traditional designs, the invention eliminates the complexity of a four-port power divider and optimizes port-to-port isolation and energy distribution through the parasitic resonance of the passive radiation arms. This significantly simplifies the design structure and reduces manufacturing costs while maintaining high-performance circular polarization characteristics. The quasi-quadrifilar helix antenna not only achieves miniaturization but also offers greater design flexibility and environmental adaptability, providing a compact, high-performance antenna solution for GNSS, satellite communications, and 6G wireless communications.

Specifically, a quasi-quadrifilar helix antenna provided by the invention comprises a ground plate 100, active radiation arms, and passive radiation arms, wherein the active radiation arms and the passive radiation arms are connected to the ground plate, the active radiation arms are fed with differential signals to generate antenna resonance, and the passive radiation arms couple with the active radiation arms that receive the differential signals to create parasitic resonance; and the two active radiation arms and the two passive radiation arms are sequentially arranged in a helically symmetric configuration around a central region of the antenna, with a parasitic resonance frequency of the passive radiation arms deviating from an antenna resonance frequency of the active radiation arms.

The two active radiation arms are configured with either equal electrical lengths or unequal electrical lengths, and the two passive radiation arms are configured with either equal electrical lengths or unequal electrical lengths; and the electrical length of the active radiation arms is one of λ₀/4 or odd multiples thereof, or λ₀/2 or integer multiples thereof, and the electrical length of the passive radiation arms deviates from one of λ₀/4 or odd multiples thereof, or λ₀/2 or integer multiples thereof, λ₀ being a wavelength corresponding to an antenna operating frequency.

Various structural transformations of the quasi-quadrifilar helix antenna will be explained below using several embodiments.

### Embodiment I

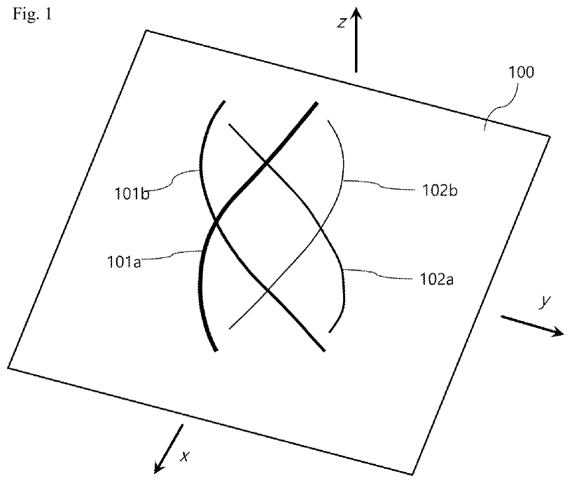

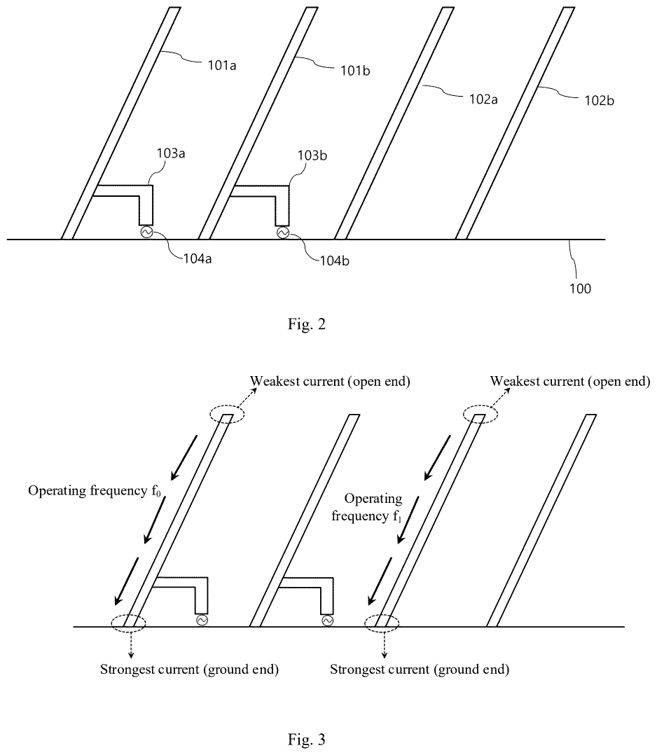

This embodiment provides a quasi-quadrifilar helix antenna, as shown in FIGS. 1 and 2, which comprises a ground plate 100, active radiation arms, and passive radiation arms. The active radiation arms consist of a first active radiation arm 101a and a second active radiation arm 101b, and the passive radiation arms consist of a first passive radiation arm 102a and a second passive radiation arm 102b; a ground end of each of the first active radiation arm 101a, the second active radiation arm 101b, the first passive radiation arm 102a, and the second passive radiation arm 102b is connected to the ground plate 100; the first active radiation arm 101a, the second active radiation arm 101b, the first passive radiation arm 102a, and the second passive radiation arm 102b are sequentially arranged in a helically symmetric configuration around a central region of the antenna and are spaced at 90 degrees; and the first active radiation arm 101a and the second active radiation arm 101b respectively receive differential signals with a 90-degree phase difference.

In FIG. 1, the first active radiation arm 101a, the second active radiation arm 101b, the first passive radiation arm 102a, and the second passive radiation arm 102b are illustrated with lines of varying thicknesses to clearly distinguish their structures. The first active radiation arm 101a, the second active radiation arm 101b, the first passive radiation arm 102a, and the second passive radiation arm 102b are sequentially arranged in a helically symmetric configuration around a central region of the antenna, forming a helical extension structure with a pitch, which radiates electromagnetic waves along the z-axis, creating a compact and efficient radiation structure. Specifically, the second passive radiation arm 102b is obtained by rotating the first passive radiation arm 102a 90 degrees clockwise around the z-axis, and the second active radiation arm 101b is generated by rotating the first active radiation arm 101a 90 degrees, resulting in a rotationally symmetrical structure where the adjacent angles between the four radiation arms are approximately 90 degrees. The ground plate 100 is positioned at the lower part of the antenna, serving as a zero-voltage reference point to provide stable grounding for the antenna.

The quasi-quadrifilar helix antenna further comprises feed branches, wherein one end of each feed branch is connected to the corresponding active radiation arm, and the other end of each feed branch is connected to a feed port. The feed branches consist of a first feed branch 103a and a second feed branch 103b, and the feed ports consist of a first feed port 104a and a second feed port 104b. One end of the first feed branch 103a is connected to the first active radiation arm 101a, and the other end of the first feed branch 103a is connected to the first feed port 104a for precise control of the input impedance matching of the first active radiation arm 101a. One end of the second feed branch 103b is connected to the second active radiation arm 101b, and the other end of the second feed branch 103b is connected to the second feed port 104b, which is responsible for optimizing the input impedance matching of the second active radiation arm 101b. Additionally, the first active radiation arm 101a and the second active radiation arm 101b receive differential signals with a phase difference of 90 degrees through the first feed port 104a and the second feed port 104b, respectively. Through this input impedance matching and differential feeding method, the active radiation arms achieve stable antenna resonance at the antenna operating frequency f₀ and generate circularly polarized signal radiation.

To enhance port-to-port isolation and circular polarization performance, the first passive radiation arm 102a and the second passive radiation arm 102b are innovatively introduced. The two passive radiation arms produce parasitic resonance (with a parasitic resonance frequency of f₁) near the operating frequency f₀, allowing for energy coupling and distribution that balances the radiation energy and ensures the symmetry and uniformity of the radiation pattern. At the same time, the parasitic resonance (f₁) serves as a decoupling structure, effectively improving the isolation between the first feed port 104a and the second feed port 104b, thereby overcoming the insufficient isolation issues caused by non-orthogonality in traditional designs.

In this embodiment, the first active radiation arm 101a, the second active radiation arm 101b, the first passive radiation arm 102a, and the second passive radiation arm 102b are all single straight arm structures. One end of each single straight arm structure is connected to the ground plate as a ground end, and the other end extends helically as an open end.

FIG. 3 is a current distribution diagram of four radiation arms in a quasi-quadrifilar helix antenna according to the invention, serving to explain its operational principle. From FIG. 3, it can be observed that the current intensity in the first active radiation arm 101a is the highest at the ground end and the weakest at the open end, exhibiting a typical standing wave distribution characteristic. This current distribution aligns with the characteristics of traditional monopole antennas or inverted-F antennas. Therefore, the electrical length of the first active radiation arm 101a and the second active radiation arm 101b is designed to be λ₀/4 or odd multiples thereof, where λ₀ is the wavelength corresponding to the antenna operating frequency f₀, thus producing stable antenna resonance at the operating frequency f₀ (the resonance frequency of the active radiation arms coincides with the antenna operating frequency). Similarly, the current distribution in the first passive radiation arm 102a also shows a standing wave pattern with maximum intensity at the ground end and minimum intensity at the open end. However, the electrical length of the first passive radiation arm 102a and the second passive radiation arm 102b slightly deviates from λ₀/4 or odd multiples thereof, resulting in parasitic resonance (f₁) near the antenna operating frequency f₀, which provides crucial support for optimizing the performance of the antenna.

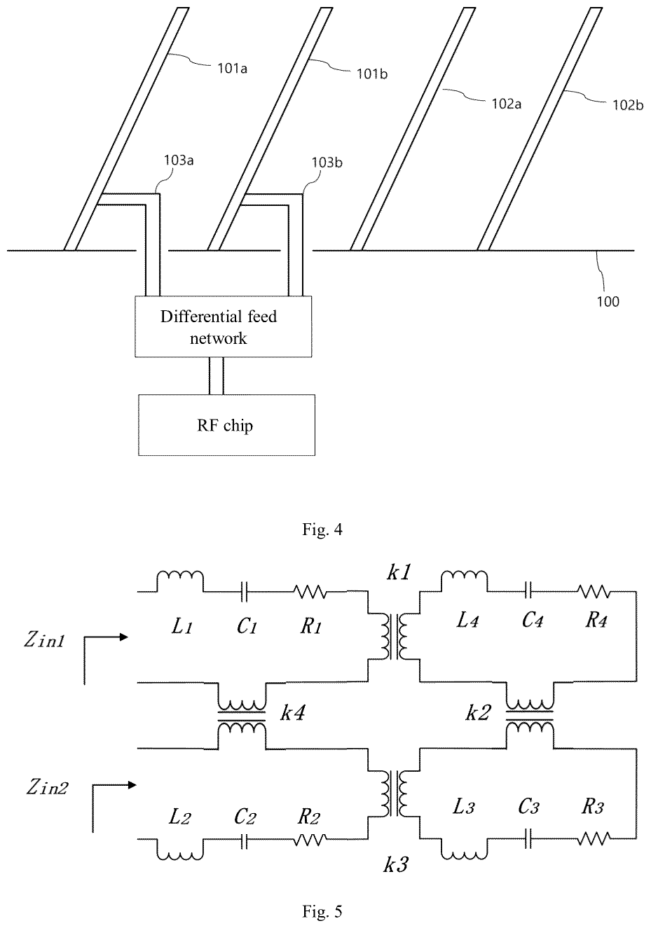

FIG. 4 further illustrates the working principle of differential feeding. The quasi-quadrifilar helix antenna comprises an RF chip and a differential feed network. A single-ended RF signal output by the RF chip is converted by the differential feed network (such as a power divider or balun circuit) into two differential signals with equal amplitudes and a 90-degree phase difference, which are fed into the first feed port 104a and the second feed port 104b respectively. Here, the feed ports represent an abstract logical concept rather than physical ports, symbolizing the RF signals from the RF chip. The first feed port 104a and the second feed port 104b are connected to the first feed branch 103a and the second feed branch 103b, respectively, thereby exciting the first active radiation arm 101a and the second active radiation arm 101b. This differential feeding method effectively ensures the generation of circularly polarized signals. The two active radiation arms generate antenna resonance at the operating frequency f₀ at the same time, facilitating signal radiation. However, due to the central rotational symmetry design of the first active radiation arm 101a and the second active radiation arm 101b, their distribution is not ideally orthogonal, making it difficult to generate completely orthogonal electric field components. Furthermore, this non-orthogonality reduces port-to-port isolation, affecting the effective realization of differential signals. Therefore, relying solely on the first active radiation arm 101a and the second active radiation arm 101b makes it challenging to form a stable circularly polarized signal.

To address the aforementioned issues, the invention innovatively introduces the first passive radiation arm 102a and the second passive radiation arm 102b. Both passive radiation arms feature a structure with one end grounded and the other end open, with their electrical length slightly deviating from λ₀/4 and odd multiples thereof, thereby generating parasitic resonance (f₁) near the antenna operating frequency f₀. This parasitic resonance serves two purposes: on one hand, it balances the radiation signals through energy transfer and uniform distribution among the four radiation arms, ensuring the symmetry and uniformity of the circularly polarized radiation; on the other hand, it acts as a decoupling structure between the first active radiation arm 101a and the second active radiation arm 101b, effectively enhancing port-to-port isolation and ensuring stable feeding of the differential signals. Consequently, this design successfully achieves the equivalent circular polarization performance of traditional quadrifilar helix antennas through the collaborative action of the two active radiation arms (101a and 101b) and the two passive radiation arms (102a and 102b).

Furthermore, the design parameters of the first passive radiation arm 102a and the second passive radiation arm 102b can be optimized by adjusting their height, width, or shape, allowing for precise control over port-to-port isolation and radiation patterns. This flexibility significantly enhances the design freedom of the antenna, enabling it to maintain robustness in complex environments and diverse requirements. Ideally, the structural parameters of the first passive radiation arm 102a and the second passive radiation arm 102b are kept consistent, with the second passive radiation arm 102b obtained by rotating the first passive radiation arm 102a by 90 degrees around its center to ensure symmetry and performance stability. Through this technical scheme, this embodiment simplifies the feed network while achieving miniaturization, high isolation, and efficient circularly polarized radiation, demonstrating significant advantages over traditional designs.

FIG. 5 is an equivalent circuit diagram of a quasi-quadrifilar helix antenna according to the invention, providing theoretical support for understanding its working mechanism. In this model, the first active radiation arm 101a and the second active radiation arm 101b are equivalently represented as a first series circuit (composed of resistor R1, inductor L1, and capacitor C1) and a second series circuit (composed of R2, L2, and C2), respectively, where the first feed port 104a and the second feed port 104b respectively correspond to voltage sources V1 and V2. The first passive radiation arm 102a and the second passive radiation arm 102b are equivalently represented as a third series circuit (composed of R3, L3, and C3) and a fourth series circuit (composed of R4, L4, and C4), respectively. The overall equivalent circuit is formed by coupling the first series circuit, the fourth series circuit, the third series circuit, and the second series circuit in sequence. Energy transfer and distribution between the circuits are realized through electromagnetic coupling, where k1 represents the coupling coefficient between the first and fourth circuits, k2 represents the coupling coefficient between the fourth and third circuits, k3 represents the coupling coefficient between the third and second circuits, and k4 represents the coupling coefficient between the first and second circuits. These coupling relationships ensure a balanced radiation distribution across the circuits.

Specifically, the fourth circuit and the third circuit are positioned between the first circuit and the second circuit, forming an additional coupling path. The coupling characteristics of this path are determined by k1, k2, and k3, with its amplitude and phase modulated by the resonant frequencies of the fourth circuit and the third circuit (i.e., the parasitic resonance f₁ of the first passive radiation arm 102a and the second passive radiation arm 102b). This additional coupling path effectively counteracts the direct electromagnetic coupling k4 between the first circuit and the second circuit (i.e., the coupling between the first active radiation arm 101a and the second active radiation arm 101b), thereby significantly enhancing the port-to-port isolation between the first feed port 104a and the second feed port 104b, ensuring stable transmission of the differential signals.

Based on the equivalent circuit model, assuming that the first circuit and the second circuit are identical, that is, L1=L2=L, C1=C2=C, R1=R2=R, and the third circuit and the fourth circuit are also identical, that is, L3-L4-L′, C3=C4-C′, R3=R4=R′, then the input impedance at the first port and the second port can be expressed as follows:

$${Z}_{i n 1} = {Z}_{i n 2} \approx ( R + j ω L + \frac{1}{j ω C} ) + \frac{{( ω {k}_{1} \sqrt{{LL}^{′}} )}^{2}}{( {R}^{′} + j ω {L}^{′} + \frac{1}{j ω {C}^{′}} )} + \frac{{( ω {k}_{4} L )}^{2}}{( R + j ω L + \frac{1}{j ω C} )}$$

where ω represents the angular frequency, corresponding to the antenna operating frequency; and j is an imaginary unit, representing the reactive power stored in capacitors or inductors. R1, R2, R3, and R4 represent the radiation energy of each radiation arm, with the radiation energies R3 and R4 of the first passive radiation arm 102a and the second passive radiation arm 102b jointly determined by the coupling coefficients k1, k2, and k3. Therefore, the electromagnetic coupling strength between the radiation arms becomes a key parameter for optimizing antenna performance.

Based on the above theory, this embodiment proposes the following design optimization solution:
(1) Optimize electromagnetic coupling: To ensure the uniformity and symmetry of the radiation pattern, it is necessary to regulate the energy distribution across the radiation arms. The energy distribution is determined by the electromagnetic coupling strength between the radiation arms, which is influenced by the frequency difference |f₀-f₁| between the active radiation arms (101a and 101b) and the passive radiation arms (102a and 102b), as well as their spatial separation. Generally, to maintain effective electromagnetic coupling strength, the minimum distance between radiation arms should be less than 0.05λ₀ (where λ₀ is the wavelength corresponding to f₀). This characteristic makes the invention particularly suitable for compact design scenarios. In strong coupling situations, the frequency difference should be appropriately increased to mitigate excessive energy interference; conversely, in weak coupling scenarios, the frequency difference should be reduced to enhance coupling efficiency. For optimal performance, the frequency difference between f₀ and f₁ should be controlled within ±20% of f₀.
(2) Optimize port-to-port isolation: To ensure the precise feeding of differential signals, the port-to-port isolation between the first feed port 104a and the second feed port 104b is crucial. The non-orthogonality of the first active radiation arm 101a and the second active radiation arm 101b can lead to a decrease in isolation, affecting the stability of signal phase and amplitude. This design effectively enhances port-to-port isolation by introducing the first passive radiation arm 102a and the second passive radiation arm 102b as decoupling structures.

Through the coupling constraints between the passive radiation arms and the active radiation arms, the invention optimizes the coupling strength between the radiation arms and the port-to-port isolation between the active radiation arms, achieving circular polarization performance that is comparable to or superior to traditional quadrifilar helix antennas. Compared to conventional designs, the antenna provided by the invention significantly reduces physical dimensions while maintaining high radiation efficiency, and it enhances design adaptability through flexible parameter adjustments. This characteristic makes it particularly suitable for applications with high precision radiation requirements, such as multi-frequency GNSS, satellite communications, and 6G wireless communications.

### Embodiment II

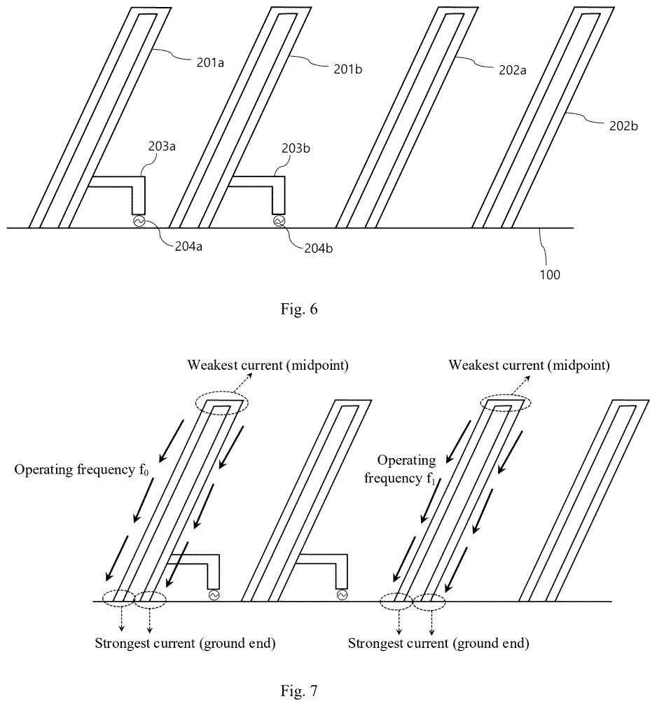

As shown in FIG. 6, the quasi-quadrifilar helix antenna comprises a ground plate 100, active radiation arms consisting of a third active radiation arm 201a and a fourth active radiation arm 201b, and passive radiation arms consisting of a third passive radiation arm 202a and a fourth passive radiation arm 202b. The four radiation arms are arranged in a centrally symmetric manner, forming an efficient radiation structure. The ground plate 100 is positioned at the lower part of the antenna, serving as a zero-voltage reference point to provide stable grounding for the antenna.

In this design, the third active radiation arm 201a and the fourth active radiation arm 201b are fed with differential signals through a third feed port 204a and a fourth feed port 204b, respectively, with a signal phase difference of 90 degrees, thereby generating antenna resonance at the antenna operating frequency f₀. The third active radiation arm 201a is grounded at both ends, with its electrical length designed to be λ₀/2 (where λ₀ is the wavelength corresponding to the antenna operating frequency f₀) or integer multiples thereof, to form stable resonance at f₀. One end of a third feed branch 203a is connected to the third feed port 204a and the other end is connected to the third active radiation arm 201a, allowing for precise control of its input impedance. Similarly, the fourth active radiation arm 201b is also grounded at both ends, with an electrical length of λ₀/2 or integer multiples thereof, resonating at f₀. One end of a fourth feed branch 203b is connected to the fourth feed port 204b and the other end is connected to the fourth active radiation arm 201b, responsible for optimizing its input impedance matching. Compared to Embodiment 1, the double-ended grounding design of the radiation arms further enhances structural stability.

FIG. 7 is a current distribution diagram of a quasi-quadrifilar helix antenna according to the invention, serving to explain the operational principle of each radiation arm. From the figure, it can be seen that the current intensity at the two ground ends of the third active radiation arm 201a is maximum, while the current intensity at the midpoint of the radiation arm is the weakest, exhibiting a typical standing wave distribution characteristic. This current distribution aligns with the characteristics of traditional loop antennas. Therefore, the electrical length of the third active radiation arm 201a and the fourth active radiation arm 201b is λ₀/2 or integer multiples thereof, ensuring antenna resonance at the antenna operating frequency f₀. Similarly, the third passive radiation arm 202a also shows maximum current intensity at the two ground ends and minimum current intensity at the midpoint, displaying standing wave characteristics. However, the electrical length of the third passive radiation arm 202a and the fourth passive radiation arm 202b is slightly above or below λ₀/2 and integer multiples thereof, resulting in parasitic resonance (f₁) near the antenna operating frequency f₀.

The third feed port 204a and the fourth feed port 204b are connected to an RF chip through a differential feed network, such as a power divider or balun circuit, to supply differential RF signals with a 90-degree phase difference. However, relying solely on the third active radiation arm 201a and the fourth active radiation arm 201b may not achieve ideal circular polarization signals, as their centrally symmetric design can lead to non-orthogonality, affecting the orthogonality of the electric field components and port-to-port isolation. To address this, this embodiment innovatively introduces the third passive radiation arm 202a and the fourth passive radiation arm 202b. Both of the passive radiation arms are grounded at both ends, and by generating parasitic resonance (f₁) near the operating frequency f₀, they serve the following functions: on one hand, they balance the radiation signals through energy transfer and uniform distribution among the four radiation arms, ensuring the symmetry and uniformity of the circularly polarized radiation; on the other hand, they act as a decoupling structure between the third active radiation arm 201a and the fourth active radiation arm 201b, enhancing port-to-port isolation through the parasitic resonance effect, thus ensuring effective feeding of the differential signals.

By employing a collaborative design of two active radiation arms (201a and 201b) and two passive radiation arms (202a and 202b), this embodiment successfully achieves the equivalent circular polarization performance of traditional quadrifilar helix antennas. Furthermore, by adjusting the parameters of the third passive radiation arm 202a and the fourth passive radiation arm 202b (such as height, width, or shape), the port-to-port isolation, beam direction, and radiation pattern characteristics can be further optimized, enhancing the design flexibility and environmental adaptability of the antenna. This design simplifies the feed network while significantly reducing manufacturing complexity, balancing miniaturization and high performance, making it particularly suitable for high-precision applications such as GNSS, satellite communications, and 6G wireless communications.

### Embodiment III

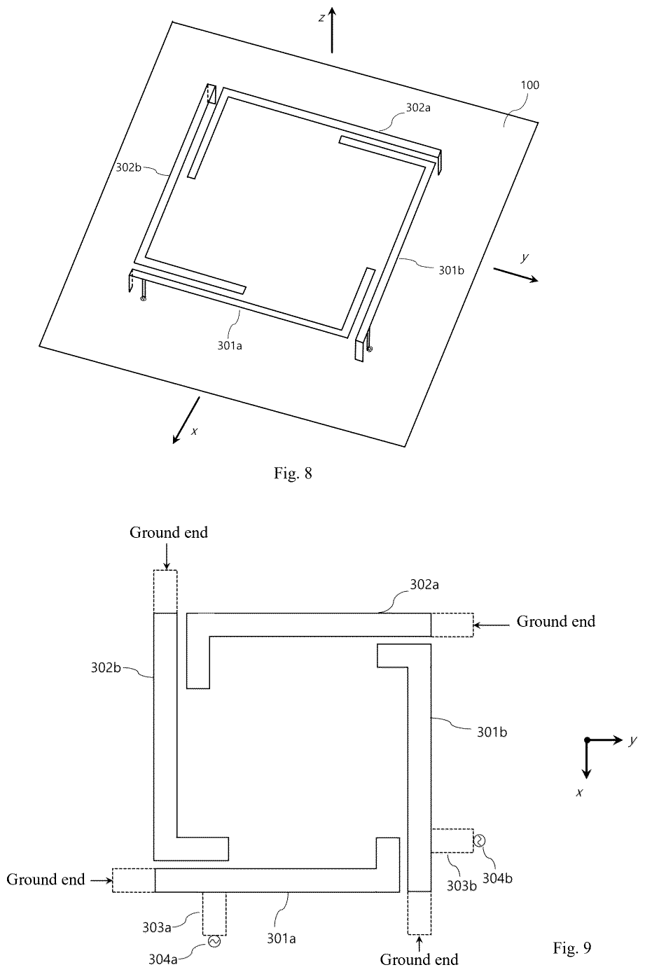

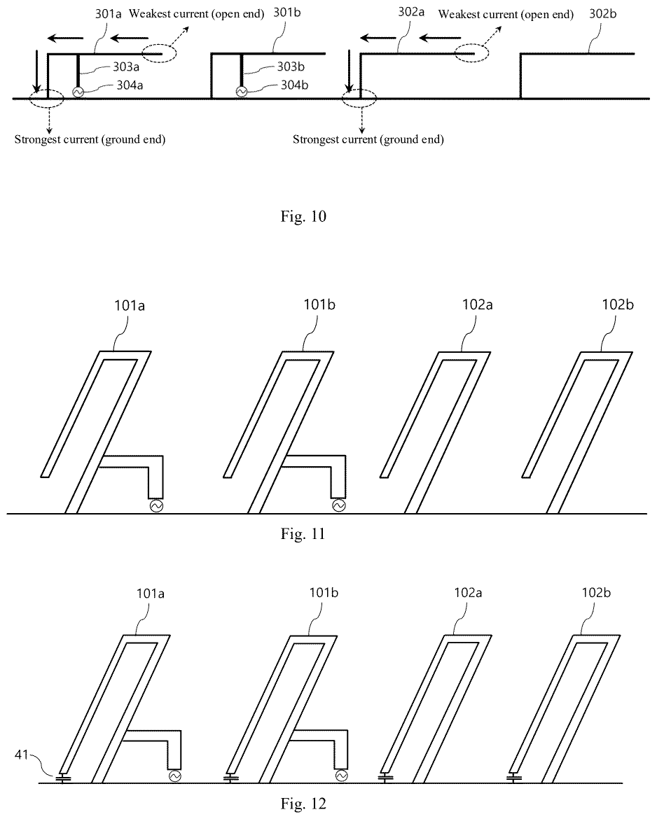

As shown in FIGS. 8-10, the low-profile quasi-quadrifilar helix antenna comprises a ground plate 100, a fifth active radiation arm 301a, a sixth active radiation arm 301b, a fifth passive radiation arm 302a, and a sixth passive radiation arm 302b. The four radiation arms are arranged in a centrally symmetric manner, forming a compact and efficient radiation structure. The ground plate 100 is positioned at the lower part of the antenna, serving as a zero-voltage reference point to provide stable grounding for the antenna.

The fifth active radiation arm 301a, the sixth active radiation arm 301b, the fifth passive radiation arm 302a, and the sixth passive radiation arm 302b are designed based on the first active radiation arm 101a, the second active radiation arm 101b, the first passive radiation arm 102a, and the second passive radiation arm 102b, or based on the third active radiation arm 201a, the fourth active radiation arm 201b, the third passive radiation arm 202a, and the fourth passive radiation arm 202b, each comprising a vertical radiation branch and a horizontal radiation branch. One end of the vertical radiation branch is connected to the ground plate 100, the other end of the vertical radiation branch is connected to one end of the horizontal radiation branch, and the other end of the horizontal radiation branch spirals out in a horizontal plane to form a low-profile inverted L antenna structure.

Unlike Embodiment I and Embodiment II, all four radiation arms in this embodiment adopt a low-profile design, significantly reducing their height (typically only 0.03λ₀), making them particularly suitable for compact devices with limited space. The fifth active radiation arm 301a and the sixth active radiation arm 301b both feature a structure that is grounded at one end and open at the other, with their electrical length designed to be λ₀/4 (where λ₀ is the wavelength corresponding to the operating frequency f₀) or odd multiples thereof to achieve stable antenna resonance at the antenna operating frequency f₀. The fifth active radiation arm 301a is fed with a differential signal through a fifth feed port 304a, with its input impedance controlled by a fifth feed branch 303a; the sixth active radiation arm 301b receives a differential signal through a sixth feed port 304b, and its input impedance is optimized by a sixth feed branch 303b. The fifth feed port 304a and the sixth feed port 304b provide differential signals with a 90-degree phase difference to excite circularly polarized radiation.

The fifth passive radiation arm 302a and the sixth passive radiation arm 302b are also designed as low-profile structures with one end grounded and the other end open. Their electrical length is slightly above or below λ₀/4 and odd multiples thereof, generating parasitic resonance (with a parasitic resonance frequency of f₁) near the antenna operating frequency f₀. The parasitic resonance plays a crucial role in achieving circular polarization performance and enhancing port-to-port isolation: on one hand, it balances the symmetry and uniformity of the radiation signals through energy coupling with the active radiation arms; on the other hand, it acts as a decoupling structure between the fifth active radiation arm 301a and the sixth active radiation arm 301b, increasing the isolation between the fifth feed port 304a and the sixth feed port 304b, ensuring effective transmission of the differential signals.

### Embodiment IV

FIGS. 11-15 showcase various alternative design options for the radiation arms in Embodiment I of the invention, further expanding the applicability of the antenna and enhancing performance through structural optimization. Depending on specific application requirements, the shape and configuration of the radiation arms can be flexibly adjusted to meet demands for impedance matching, frequency tuning, and miniaturization.

Referring to FIG. 11, along with FIG. 2, this design adopts a U-shaped configuration for the radiation arms, significantly improving the compactness of the antenna, making it easier to integrate into space-constrained devices while maintaining good radiation performance. Additionally, the design incorporates a serpentine path to extend the current path, increasing the adjustable range of the resonance modes, particularly optimizing resonance performance in the low-frequency band, suitable for applications requiring broadband or low-frequency adaptation.

Referring to FIG. 12, along with FIG. 2, the quasi-quadrifilar helix antenna further comprises first capacitive elements 41, one end of each first capacitive element 41 is connected to the open end of the corresponding radiation arm, and the other end of each first capacitive element 41 is electrically connected to the ground plate 100. The open ends of the first active radiation arm 101a, the second active radiation arm 101b, the first passive radiation arm 102a, and the second passive radiation arm 102b are loaded with the first capacitive elements 41, which are electrically connected to the ground plate 100. This capacitive effect adjusts the resonant frequency and optimizes input impedance matching, enhancing the performance stability of the antenna at the operating frequency f₀.

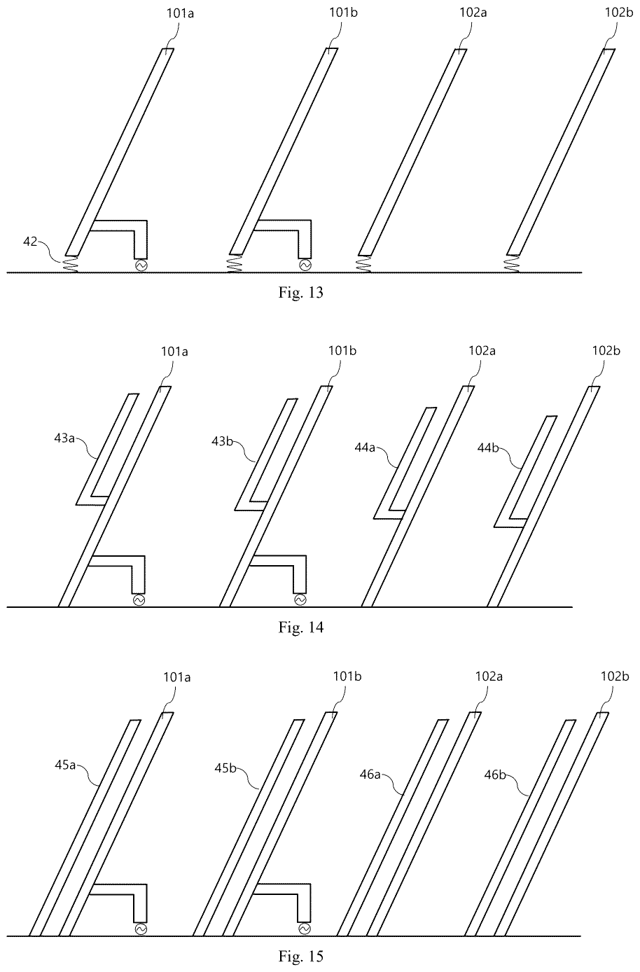

As shown in FIG. 13, the quasi-quadrifilar helix antenna further comprises first inductive elements 42. The ground ends of the first active radiation arm 101a, the second active radiation arm 101b, the first passive radiation arm 102a, and the second passive radiation arm 102b are respectively connected to one ends of the first inductive elements 42, and the other end of each first inductive element 42 is electrically connected to the ground plate. By loading the first inductive elements 42 at the ground ends of the first active radiation arm 101a, the second active radiation arm 101b, the first passive radiation arm 102a, and the second passive radiation arm 102b, the inductive effect effectively lowers the resonance frequency and enhances radiation efficiency in the low-frequency band. These loading schemes further improve the resonance characteristics, supporting miniaturized designs suitable for space- and cost-sensitive applications.

Referring to FIG. 14, along with FIG. 2, the quasi-quadrifilar helix antenna further comprises current branches for forming additional current paths, wherein one or more of the active radiation arms and the passive radiation arms are connected to the current branches. The current branches consist of a first branch 43a, a second branch 43b, a third branch 44a, and a fourth branch 44b. The first branch 43a is connected to the first active radiation arm 101a, the second branch 43b is connected to the second active radiation arm 101b, the third branch 44a is connected to the first passive radiation arm 102a, and the fourth branch 44b is connected to the second passive radiation arm 102b. One or more of the first active radiation arm 101a, the second active radiation arm 101b, the first passive radiation arm 102a, and the second passive radiation arm 102b can select the configuration of the current branches.

The first branch 43a and the second branch 43b are respectively connected to the first active radiation arm 101a and the second active radiation arm 101b, forming additional current paths through direct connections, which generate antenna resonance corresponding to a second operating frequency f₂, achieving dual-band or wideband functionality. Optionally, the third branch 44a and the fourth branch 44b are connected to the first passive radiation arm 102a and the second passive radiation arm 102b respectively, creating additional current paths that generate parasitic resonance f₃ near the second operating frequency f₂, further optimizing port-to-port isolation and energy distribution in the f₂ band. This design constructs a quasi-quadrifilar helix antenna with dual-band characteristics through the synergistic effect of active and passive radiation arms.

Referring to FIG. 15, along with FIGS. 2 and 13, the quasi-quadrifilar helix antenna further comprises electromagnetic coupling branches that spatially electromagnetically couple to one or more of the active and/or passive radiation arms, wherein one or more of the active radiation arms and the passive radiation arms are equipped with the electromagnetic coupling branches, and the electromagnetic coupling branches are located on one sides of the active radiation arms and/or the passive radiation arms.

The electromagnetic coupling branches consist of a fifth branch 45a, a sixth branch 45b, a seventh branch 46a, and an eighth branch 46b. The fifth branch 45a is positioned with a spacing on one side of the first active radiation arm 101a to form spatial electromagnetic coupling, the sixth branch 45b is positioned with a spacing on one side of the second active radiation arm 101b to create spatial electromagnetic coupling, the seventh branch 46a is positioned with a spacing on one side of the first passive radiation arm 102a to form spatial coupling, and the eighth branch 46b is positioned with a spacing on one side of the second passive radiation arm 102b to establish spatial coupling. One or more of the first active radiation arm 101a, the second active radiation arm 101b, the first passive radiation arm 102a, and the second passive radiation arm 102b can choose the configuration of the electromagnetic coupling branches.

The fifth branch 45a and the sixth branch 45b are indirectly connected to the first active radiation arm 101a and the second active radiation arm 101b respectively, generating antenna resonance at the operating frequency f₂ through spatial electromagnetic coupling at the first feed port 104a and the second feed port 104b. The fifth branch 45a and the sixth branch 45b can be designed as structures that are grounded at one end or at both ends, with an electrical length of λ₂/4 (where λ₂ is the wavelength corresponding to the second operating frequency f₂) or integer multiples thereof, producing resonance at f₂. Optionally, the seventh branch 46a and the eighth branch 46b interact with the first passive radiation arm 102a and the second passive radiation arm 102b through spatial coupling, generating parasitic resonance f₃ near f₂, further enhancing port decoupling and energy uniformity in the f₂ band. This non-contact coupling method enhances frequency coverage, achieving dual-band or wideband characteristics.

The quasi-quadrifilar helix antenna in this invention may also adopt multiple sets of radiation arms, distributed in a rotationally symmetric manner to achieve more advanced functions. For example, a first set of radiation arms comprises two active radiation arms and two passive radiation arms, where the two active radiation arms operate at the first operating frequency f₀, and the two passive radiation arms generate parasitic resonance (f₁) near f₀, optimizing circular polarization and port-to-port isolation in the first frequency band. Similarly, a second set of radiation arms comprises two active radiation arms and two passive radiation arms, with the two active radiation arms working at the second operating frequency f₂, and the two passive radiation arms producing parasitic resonance f₃ near f₂, enhancing circular polarization and port-to-port isolation in the second frequency band. By adjusting the arrangement and orientation of the two sets of radiation arms, it ensures that their operating frequencies do not interfere with each other, thus achieving dual-band characteristics. This shared-aperture antenna design significantly enhances system integration, making it suitable for multi-band applications.

Capacitive elements possess capacitive characteristics and can be categorized as either lumped or distributed elements. For example, lumped elements include chip capacitors, variable capacitors, electrolytic capacitors, ceramic capacitors, and film capacitors. Distributed capacitive elements may include parallel wires (two or more wires arranged in parallel, with the capacitance value adjusted by changing the spacing and length of the wires), transmission line structures (such as microstrip lines or coaxial cables), capacitive plates (two parallel metal plates separated by a dielectric layer or air gap), and PCB planar capacitive structures (where metallic patterns in finger-like or interleaved configurations are printed on a PCB to optimize capacitive characteristics).

These capacitive elements can be used individually or in combination. For example, by connecting multiple capacitive elements in series or parallel, specific equivalent capacitance can be achieved. Additionally, capacitive elements may be replaced with a combination structure of capacitive and inductive elements to optimize the resonance performance of the antenna. Similarly, inductive elements can be either lumped elements (such as chip inductors or chip resistors) or distributed elements (such as wires and coils). Likewise, multiple inductive elements can be combined to enhance the overall performance of the antenna.

The structural variations shown in FIGS. 11 to 15 are also applicable to the radiation arm structures of the third active radiation arm, the fourth active radiation arm, the third passive radiation arm, and the fourth passive radiation arm in Embodiment II.

Through the above optimizations, the invention significantly enhances the resonance control capability and polarization stability of the antenna while maintaining a compact design. The diversified design of the radiation arm shapes, along with the implementation of dual-band configurations, allows the quasi-quadrifilar helix antenna to adapt to the needs of various wireless communication systems, including GNSS, drone communications, 6G wireless communications, and vehicle positioning, demonstrating excellent environmental adaptability and performance advantages.

### Embodiment V

Referring to FIG. 16, along with FIG. 2, the quasi-quadrifilar helix antenna further comprises feed branches, with each feed branch disposed on one side of the corresponding active radiation arm, wherein one end of each feed branch forms a coupling gap with the corresponding active radiation arm, and the other end of each feed branch is connected to a feed port. The feed branches consist of a first feed branch 103a and a second feed branch 103b, and the feed ports consist of a first feed port 104a and a second feed port 104b. One end of the first feed branch 103a is connected to the first feed port 104a, and the other end remains open, forming a coupled feeding structure. Similarly, one end of the second feed branch 103b is connected to the second feed port 104b, and the other end remains open, also creating a coupled feeding structure. This design allows for precise control of the input impedance of the first active radiation arm 101a by adjusting the resonant frequency of the first feed branch 103a and its coupling strength with the first active radiation arm 101a, which is beneficial for achieving wideband characteristics and enhancing the bandwidth adaptability of the antenna.

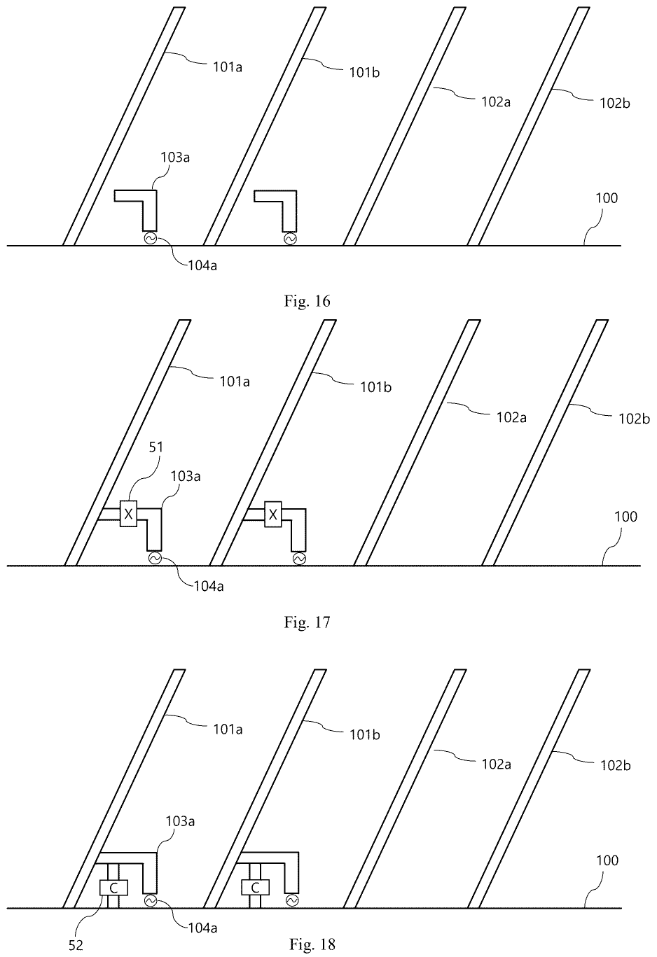

Referring to FIG. 17, along with FIG. 2, the quasi-quadrifilar helix antenna further comprises first elements 51. One end of the first feed branch 103a is electrically connected to the first active radiation arm 101a in series through the corresponding first element 51, and one end of the second feed branch 103b is electrically connected to the second active radiation arm 101b in series through the corresponding first element 51. The first element 51 may be a capacitive element, an inductive element, or a combination of both. By adjusting the capacitance or inductance value of the first element 51, effective matching and tuning of the input impedance of the antenna can be achieved. The specific choice depends on the optimization goals, further enhancing the flexibility and tunability of input impedance matching.

Referring to FIG. 18, along with FIG. 2, the quasi-quadrifilar helix antenna further comprises second elements 52, the second elements 52 are connected in parallel to one sides of the first feed branch 103a and the second feed branch 103b respectively, and the second element 52 may be a capacitive element, an inductive element, or a combination of both. The second elements 52 are connected in parallel to one sides of the first feed branch 103a and the second feed branch 103b respectively, forming a parallel feeding loop. This structure introduces parallel components to further adjust the input impedance matching characteristics of the first active radiation arm 101a and the second active radiation arm 101b, effectively expanding the bandwidth or optimizing performance in specific frequency bands.

The feeding schemes shown in FIGS. 16 to 18 are also applicable to the third active radiation arm 201a and the fourth active radiation arm 201b. In the optimal design, the structural parameters and feeding methods of the first active radiation arm 101a and the second active radiation arm 101b remain consistent; specifically, the second active radiation arm 101b is obtained by rotating the first active radiation arm 101a by 90 degrees about its center, ensuring the symmetry of the differential signals and the stability of circularly polarized radiation.

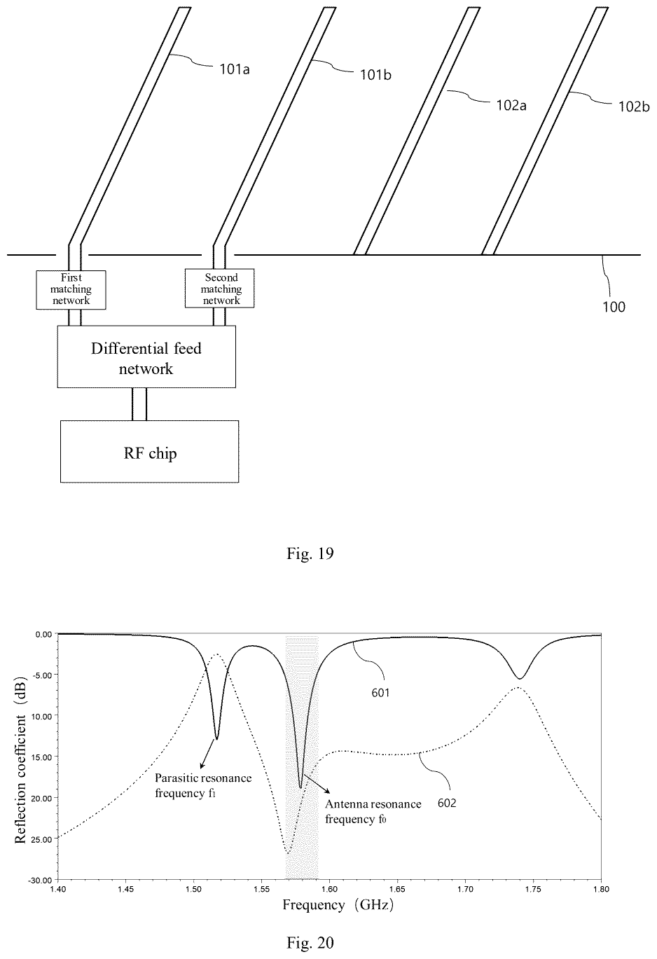

As shown in FIG. 19, the quasi-quadrifilar helix antenna further comprises matching networks, a differential feed network, and an RF chip, wherein the differential feed network is connected to the active radiation arms through the matching networks, and the RF chip is connected to the differential feed network. The matching networks and the feed branches are two parallel approaches for adjusting the input impedance matching of the antenna. In FIG. 19, the matching networks replace the feed branch structure shown in FIG. 4. The matching networks consist of a first matching network and a second matching network.

The signals output from the RF chip are converted into differential signals with a 90-degree phase difference through the differential feed network, which are then fed into the first active radiation arm 101a and the second active radiation arm 101b respectively. This setup is equivalent to directly connecting the first feed port 104a and the second feed port 104b to the first active radiation arm 101a and the second active radiation arm 101b respectively, without going through the feed branches. To achieve good input impedance matching, the two feeding signals pass through the first matching network and the second matching network respectively before connecting to their respective radiation arms. The matching networks can utilize common configurations such as PI-type, L-type, or other forms to adjust the input impedance, enhance matching efficiency, and ensure effective transmission of RF signals and stable antenna performance. It is important to note that the input impedance matching in this invention can be achieved not only through the feed branch structure illustrated in FIGS. 16 to 19 but also by incorporating various feeding and tuning methods commonly used in PIFA antennas. For example, the input impedance can be fine-tuned and optimized by adjusting the position of the feed ports (such as moving along the length of the radiation arms), optimizing grounding locations, or introducing shorting pins or shorting plates to regulate the electrical length and standing wave characteristics of the antenna. Additionally, tuning elements such as series or parallel inductors, capacitors, or varactor diodes can be introduced into the feeding path to achieve precise matching control and wideband characteristic adjustments.

In practical implementation, these control methods can be used individually or in combination with differential feed structures to meet the comprehensive performance requirements for antenna miniaturization, high isolation, wideband, or dual-band operation in various scenarios. Through the diverse design of the feeding and matching methods, the invention not only enhances the design flexibility and matching capability of the quasi-quadrifilar helix antenna but also improves its adaptability to multiple scenarios and standards in wireless communication systems, such as GNSS, satellite communications, drone links, and 6G. This offers good engineering practicality and promotional value.

FIGS. 20 to 26 present the simulation data from Embodiment I of the invention. The parameters such as scattering coefficient, transmission coefficient, axial ratio, and circular polarization gain verify the performance advantages and key features of the design.

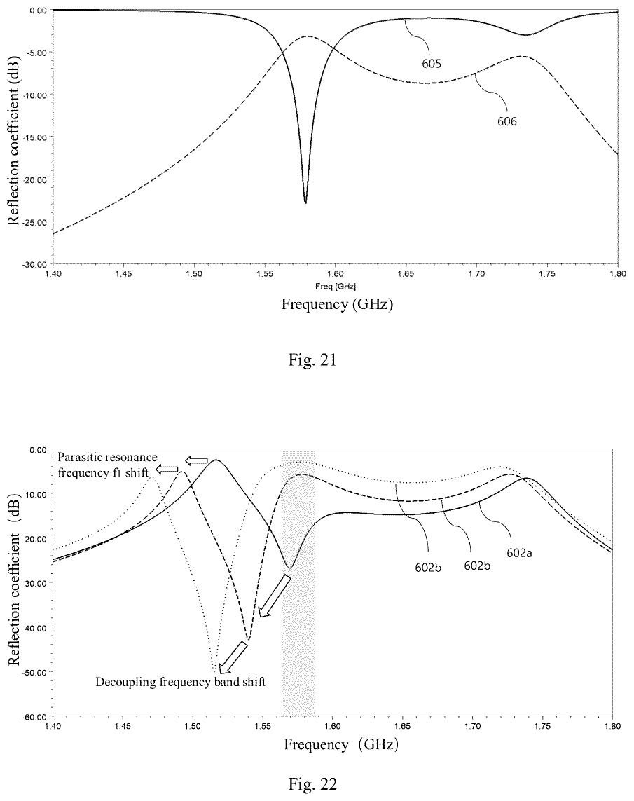

FIG. 20 is a graph of scattering coefficients for this embodiment, where the reflection coefficient curve 601 reflects the antenna resonance (f₀) generated at the first feed port 104a and the second feed port 104b at the operating frequency (such as the L1 band), demonstrating excellent input impedance matching characteristics. This resonance is produced jointly by the first active radiation arm 101a and the second active radiation arm 101b. Additionally, the curve clearly shows the parasitic resonance (f₁) generated by the first passive radiation arm 102a and the second passive radiation arm 102b, which occurs at a frequency lower than the antenna resonance (f₀), distinguishing this characteristic from traditional quadrifilar helix antennas and highlighting the innovation of this invention. The transmission coefficient curve 602 indicates the energy transfer between the first feed port 104a and the second feed port 104b, reflecting the coupling strength between the ports. At the antenna resonance (f₀) band, the port-to-port isolation reaches up to 20 dB, indicating excellent decoupling performance. In contrast, FIG. 21 presents a scenario containing only the first active radiation arm 101a and the second active radiation arm 101b (without the first passive radiation arm 102a and the second passive radiation arm 102b). The reflection coefficient curve 605 shows that the antenna resonance (f₀) is essentially unaffected, but the parasitic resonance (f₁) disappears. In this case, the port-to-port isolation is only about 3 dB, severely limiting the effective feeding of orthogonal differential signals.

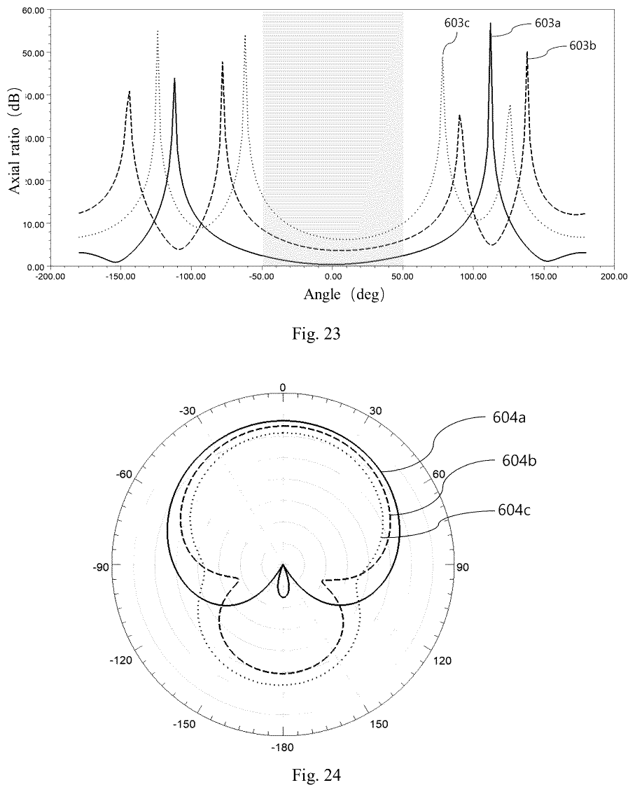

FIGS. 22 to 24 further illustrate the impact of parasitic resonance (f₁) variations on antenna performance. FIG. 22 shows the changes in transmission coefficient, FIG. 23 presents the changes in axial ratio, and FIG. 24 displays the changes in circular polarization gain. As shown in FIG. 22, when the frequency of the parasitic resonance (f₁) decreases, the port-to-port isolation at the antenna resonance (f₀) gradually deteriorates. Specifically, the higher isolation (approximately 20 dB) corresponding to curve 602a ensures the excellent axial ratio curve 603a in FIG. 23 (close to the ideal value) and the high circular polarization gain curve 604a in FIG. 24. When f₁ decreases to the state represented by curve 602b, the isolation worsens, leading to a deterioration of the axial ratio curve 603b to over 4 dB and a reduction in the gain curve 604b by about 2 dB (compared to curve 604a). As f₁ further decreases to the state represented by curve 602c, the isolation continues to decline, the axial ratio curve 603c deteriorates to over 8 dB, and the gain curve 604c decreases by about 4 dB (compared to curve 604a). These data indicate that the frequency position of the parasitic resonance (f₁) is crucial for isolation, axial ratio, and gain.

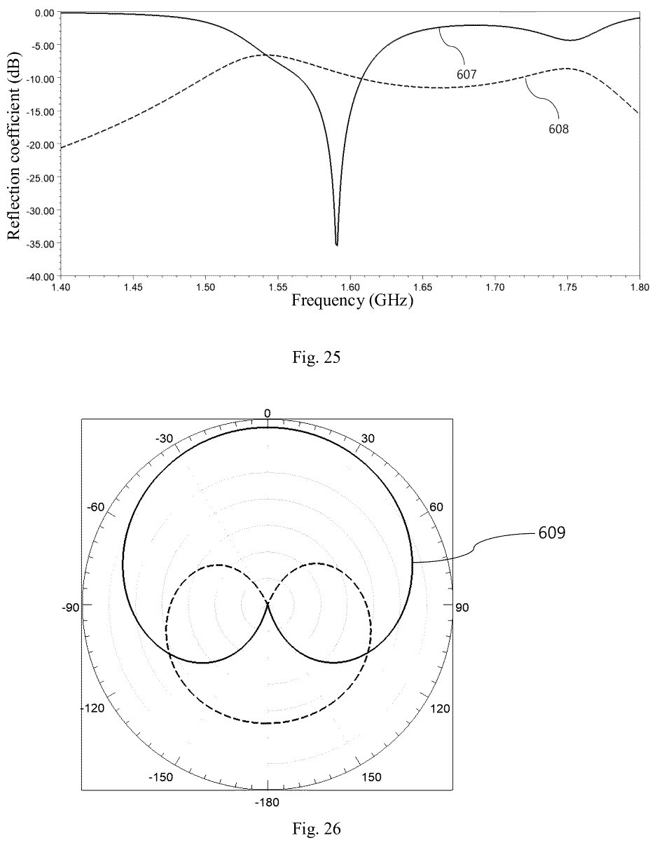

FIGS. 25 and 26 present the simulation results of a traditional quadrifilar helix antenna for comparison. The reflection coefficient curve 607 in FIG. 25 indicates that the traditional design also achieves excellent input impedance matching at the operating frequency; however, the transmission coefficient curve 608 shows that its port-to-port isolation is only about 7 dB. Nonetheless, the circular polarization gain curve 609 in FIG. 26 still demonstrates a high gain. This is attributed to the traditional quadrifilar helix antenna using four ports to feed differential signals, which enforces orthogonal electric field components and circular polarization characteristics through a complex power distribution network. However, this significantly increases design complexity and manufacturing costs.

The simulation results indicate that by introducing parasitic resonance (f₁) through the first passive radiation arm 102a and the second passive radiation arm 102b, the invention effectively achieves decoupling between the first feed port 104a and the second feed port 104b, thereby ensuring stable feeding of the differential signals. Additionally, the electromagnetic coupling between the active radiation arms and the passive radiation arms optimizes the symmetry and uniformity of radiation, allowing the antenna to achieve wide axial ratio and high gain circular polarization performance using only two feed ports. Compared to traditional quadrifilar helix antennas, this design not only reduces complexity and cost but also maintains excellent radiation characteristics within a compact structure, making it suitable for high-demand scenarios such as GNSS and satellite communications.

In some other optional embodiments, the invention also proposes an electronic device that comprises the quasi-quadrifilar helix antenna described in the above optional embodiments. For example, the electronic device may be a communication module, an onboard station, or a drone.

The quasi-quadrifilar helix antenna proposed in the invention exhibits three technical advantages in terms of structure, performance, and application adaptability:
(1) Simplified and miniaturized design: Unlike traditional quadrifilar helix antennas that rely on four feed ports and complex power distribution networks, the invention innovatively utilizes only two feed ports to achieve differential signal feeding. This design significantly reduces the number of components, complexity, and manufacturing costs of the differential circuit, while delivering equivalent circular polarization performance in a compact structure, providing an efficient solution for the integration of miniaturized devices.
(2) High performance and adjustability: The invention significantly enhances the performance and design flexibility of the antenna by introducing two passive radiation arms. On one hand, the passive radiation arms optimize the port-to-port isolation between the two active radiation arms through parasitic resonance (f₁), ensuring ideal input for differential signals, which guarantees excellent circular polarization axial ratio and high gain characteristics. On the other hand, the electromagnetic coupling among the four radiation arms enables uniform distribution of radiation energy, further enhancing the symmetry of the radiation pattern. Additionally, by adjusting the parameters of the passive radiation arms (such as electrical length, height, and shape), the resonant frequency and performance characteristics can be flexibly tuned, allowing the antenna to adapt to diverse and complex application scenarios.
(3) Enhanced application adaptability: Thanks to its simplified design and high adjustability, the invention significantly improves the environmental adaptability and system integration of the antenna while maintaining high performance. Whether for single-band optimization or dual-band shared-aperture design, the antenna can meet the demands of various wireless communication systems, such as GNSS, drone communications, 6G wireless communications, and vehicle positioning, through structural optimization, demonstrating exceptional robustness and practicality.

In summary, the quasi-quadrifilar helix antenna of the invention, through innovative structural design and performance optimization, not only overcomes the complexity and size limitations of traditional designs but also achieves significant breakthroughs in performance and application flexibility, providing important support for the development of modern wireless communication technologies.

The structure of the antenna can be adjusted according to specific design needs, allowing for different forms of radiation arms, ground plates, layout styles, and feeding methods to meet various requirements for input impedance matching, operating frequency, and structural optimization. The shapes of the antennas in the various embodiments of the invention are merely illustrative, and they are not confined to the shapes illustrated in the accompanying drawings of the specification of the invention.

The above is a further detailed description of the invention combined with specific preferred embodiments, and it cannot be considered that the specific implementation of the invention is limited to these descriptions. For those of ordinary skill in the art to which the invention belongs, under the premise of not deviating from the concept of the invention, several simple deductions or substitutions can be made, all of which should be regarded as belonging to the protection scope of the invention.

What is claimed is:

1. A quasi-quadrifilar helix antenna, comprising a ground plate, active radiation arms, and passive radiation arms, wherein the active radiation arms and the passive radiation arms are connected to the ground plate, the active radiation arms are fed with differential signals to generate antenna resonance, and the passive radiation arms couple with the active radiation arms that receive the differential signals to create parasitic resonance; and the two active radiation arms and the two passive radiation arms are sequentially arranged in a helically symmetric configuration around a central region of the antenna, with a parasitic resonance frequency f₁ of the passive radiation arms deviating from an antenna resonance frequency f₀ of the active radiation arms.

2. The quasi-quadrifilar helix antenna according to claim 1, wherein the two active radiation arms are configured with either equal electrical lengths or unequal electrical lengths, and the two passive radiation arms are configured with either equal electrical lengths or unequal electrical lengths; and the electrical length of the active radiation arms is one of λ₀/4 or odd multiples thereof, or λ₀/2 or integer multiples thereof, and the electrical length of the passive radiation arms deviates from one of λ₀/4 or odd multiples thereof, or λ₀/2 or integer multiples thereof, λ₀ being a wavelength corresponding to an antenna operating frequency f₀.

3. The quasi-quadrifilar helix antenna according to claim 1, wherein the active radiation arms consist of a first active radiation arm and a second active radiation arm, and the passive radiation arms consist of a first passive radiation arm and a second passive radiation arm; one end of each of the first active radiation arm, the second active radiation arm, the first passive radiation arm, and the second passive radiation arm is connected to the ground plate; the first active radiation arm, the second active radiation arm, the first passive radiation arm, and the second passive radiation arm are sequentially arranged in a helically symmetric configuration around the central region of the antenna; and an electrical length of the first active radiation arm and the second active radiation arm is λ₀/4 or odd multiples thereof, and an electrical length of the first passive radiation arm and the second passive radiation arm deviates from λ₀/4 or odd multiples thereof;
or the active radiation arms consist of a third active radiation arm and a fourth active radiation arm, and the passive radiation arms consist of a third passive radiation arm and a fourth passive radiation arm; two ends of each of the third active radiation arm, the fourth active radiation arm, the third passive radiation arm, and the fourth passive radiation arm are connected to the ground plate; the third active radiation arm, the fourth active radiation arm, the third passive radiation arm, and the fourth passive radiation arm are sequentially arranged in a helically symmetric configuration around the central region of the antenna; and an electrical length of the third active radiation arm and the fourth active radiation arm is λ₀/2 or integer multiples thereof, and an electrical length of the third passive radiation arm and the fourth passive radiation arm deviates from λ₀/2 or integer multiples thereof.

4. The quasi-quadrifilar helix antenna according to claim 3, further comprising first capacitive elements, wherein open ends of one or more of the first active radiation arm, the second active radiation arm, the first passive radiation arm, and the second passive radiation arm are electrically connected to the ground plate through the first capacitive elements respectively.

5. The quasi-quadrifilar helix antenna according to claim 3, further comprising first inductive elements, wherein ground ends of one or more of the first active radiation arm, the second active radiation arm, the first passive radiation arm, and the second passive radiation arm are electrically connected to the ground plate through the first inductive elements;
or one or two ends of one or more of the third active radiation arm, the fourth active radiation arm, the third passive radiation arm, and the fourth passive radiation arm are electrically connected to the ground plate through the first inductive elements.

6. The quasi-quadrifilar helix antenna according to claim 1, wherein the active radiation arm and the passive radiation arm each have a vertical radiation branch and a horizontal radiation branch, with the vertical radiation branch connected to the ground plate, and the horizontal radiation branch connected to the vertical radiation branch and spiraling out in a horizontal plane to form a low-profile antenna structure.

7. The quasi-quadrifilar helix antenna according to claim 1, further comprising current branches for forming additional current paths, wherein one or more of the active radiation arms and the passive radiation arms are connected to the current branches.

8. The quasi-quadrifilar helix antenna according to claim 1, further comprising electromagnetic coupling branches that spatially electromagnetically couple to one or more of the active and/or passive radiation arms, wherein one or more of the active radiation arms and the passive radiation arms are equipped with the electromagnetic coupling branches, and the electromagnetic coupling branches are located on one sides of the active radiation arms and/or the passive radiation arms.

9. The quasi-quadrifilar helix antenna according to claim 1, further comprising feed branches, with each feed branch disposed on one side of the corresponding active radiation arm, wherein one end of each feed branch forms a coupling gap with the corresponding active radiation arm, and the other end of each feed branch is connected to a feed port.

10. The quasi-quadrifilar helix antenna according to claim 1, further comprising feed branches, wherein one end of each feed branch is connected to the corresponding active radiation arm, and the other end of each feed branch is connected to a feed port.

11. The quasi-quadrifilar helix antenna according to claim 10, further comprising first elements, wherein a first element is connected in series along a feed branch between the feed port and the active radiation arm, and the first element is a capacitive element, an inductive element, or a combination of both.

12. The quasi-quadrifilar helix antenna according to claim 10, further comprising second elements, wherein a second element is connected in parallel to a corresponding feed branch, and the second element is a capacitive element, an inductive element, or a combination of both.

13. The quasi-quadrifilar helix antenna according to claim 9, further comprising a differential feed network and an RF chip, wherein the differential feed network is connected to the feed ports, and the RF chip is connected to the differential feed network.

14. The quasi-quadrifilar helix antenna according to claim 1, further comprising matching networks, a differential feed network, and an RF chip, wherein the differential feed network is connected to the active radiation arms through the matching networks, and the RF chip is connected to the differential feed network.

15. The quasi-quadrifilar helix antenna according to claim 1, wherein the two active radiation arms are fed with differential signals that have a phase difference, with 90 degrees being a representative example.

16. The quasi-quadrifilar helix antenna according to claim 1, wherein the active radiation arms fed with differential signals generate an antenna resonance frequency f₀, the passive radiation arms produce a parasitic resonance frequency f₁, and a frequency difference between f₀ and f₁ is controlled within ±20% of f₀.

17. The quasi-quadrifilar helix antenna according to claim 1, wherein a smallest gap between any two radiation arms is smaller than 0.05λ₀, λ₀ being a wavelength corresponding to an antenna operating frequency f₀.
